(19) United States
(12) Patent Application Publication
(10) Pub. No.: US 2014/0358753 A1
(43) Pub. Date: Dec. 4, 2014

(54) HOUSING LOTTERY SYSTEM AND METHOD

(71) Applicant: Keith Jones, Miami, FL (US)

(72) Inventor: Keith Jones, Miami, FL (US)

(21) Appl. No.: 13/904,625

(22) Filed: May 29, 2013

(51) Int. Cl. G06Q 50/16; G06Q 40/00; G07F 17/32

(52) U.S. Cl. CPC G06Q 50/163; G07F 17/329; G06Q 40/00
USPC 705/35

(57) ABSTRACT

A system for a housing lottery comprising at least one property, such as a foreclosure, to be sold through the housing lottery. A lottery management authority manages the housing lottery. Accordingly, properties are listed therewith for inclusion in the lottery. The system also includes at least one lottery ticket priced according to the property for which it corresponds or to financial obligations tied to that property, and at least one participant who purchases one or more lottery tickets for one or more different properties. The lottery management authority conducts at least one drawing for each property, and distributes the proceeds of the lottery ticket sales to satisfy financial obligations such as outstanding liens including mortgages or loans, taxes, insurance, commission, down payment to the displaced homeowner, and profits to the local municipality to spur the economy. Also a method of conducting a housing lottery as described.

### RELATED APPLICATIONS

This application relates to and claims priority front U.S. provisional application No. 61/660,453 filed on 15 Jun. 2012 which is titled, “HOUSING LOTTERY SYSTEM AND METHOD” and is incorporated herein in its entirety by reference.

### BACKGROUND OF THE INVENTION

1. Field of the Invention

The present invention relates to lotteries, and more specifically, to a lottery for houses, condominiums, and other real estate properties in areas of financial crisis, to stabilize the housing market, real estate value, and the economy.

2. Description of the Related Art

Lotteries have been conducted for centuries, such as by state or local governments, as a means of raising money for various projects that benefit the community. For example, in colonial America, John Hancock helped manage a lottery in 1762 to raise money to rebuild Faneuil Hall in Boston after damage from a fire. George Washington managed a lottery to fund the building of roads over the Cumberland Mountains. The Continental Congress even used lotteries to raise money to finance the American Revolution. More recently, state governments such as Florida have been operating lotteries for decades, using part of the proceeds to fund state level projects such as college scholarships and education.

Lotteries have typically been conducted to raise money for a particular purpose, offering a “prize” for the winner which is most frequently a monetary reward derived from ticket sales.

One of the most pressing issues currently consuming the attention and worry of the United States revolves around the increased numbers of foreclosures that are occurring. The sub-prime mortgage crisis that befell the United States in the late 2000's was a large aspect of the financial crisis of the same time period, which led to the recession still being experienced by the U.S. today. The rise in sub-prime mortgages being issued to people who could not afford them led to a rise in mortgage delinquencies and foreclosures.

For example, in 2007 there were almost 1.3 million properties foreclosed on by lenders, which represented a 79% increase over 2006. In 2008 this number rose to 2.3 million, an 81% increase over 2007. And in 2009 a 21% increase over the previous year to 2.9 million foreclosed properties. As foreclosure rates increased, the value of the securities backing these mortgages eroded, and in turn, the value of these properties plummeted and the companies and individuals investing in mortgage backed securities suffered losses on their investments. The end result was a loss not only to individual homeowners, but also to the global economy in the trillions of dollars.

Since the housing bubble burst, foreclosure rates have skyrocketed, particularly in certain states including California and Florida. As of the spring of 2012, there were roughly one million homes in foreclosure in the U.S., with several million more in the pipeline, and 872,000 previously foreclosed homes still in the hands of the banks. Though just one part of the financial crisis, the housing bubble has had devastating consequences for the United States economy, including the automobile and banking industries, and reverberating impact on the global economy as well.

The Federal Reserve has instituted a number of facilities and programs in an attempt to address and combat the financial crisis. The U.S. government has passed laws such as the Emergency Economic Stabilization Act of 2008 and government backed bailouts to provide relief from the crisis. However, many of these efforts do not help at the local level where the average citizen is feeling the effects of the housing and financial crises, and where economic recovery begins. Even local municipalities and governments are suffering the effects and are having a difficult time with local budgets and spending. In addition, existing federal efforts do not provide sufficient relief relative to the large number of people affected, such as the many homeowners who have had their homes foreclosed for delinquencies and the numerous local and state governments and municipalities being forced to make uncomfortable budget cuts, even job cuts, in an attempt to stay afloat financially.

Accordingly, the market needs a better way of providing relief from foreclosure in a meaningful way. Such relief should not only affect foreclosures and the housing market, but would also benefit the local community as a whole to help the economy to rebound.

### III. SUMMARY OF THE INVENTION

The present invention is directed to a system and method for a housing lottery in which properties, such as foreclosures and other financially endangered properties, may be “won” and the proceeds of lottery ticket sales are used to satisfy financial obligations of the property. Specifically, at least one property is identified and listed with a lottery management authority. Though this property may be a foreclosure, or may be appropriate for foreclosure, such status is not required, and it may be any property, commercial or residential.

Lottery tickets are sold for particular properties, purchased by participants desirous of acquiring the corresponding property. The lottery management authority facilitates the conducting of at least one drawing to identity a winning participant, who then takes over ownership of the property. Proceeds of the lottery ticket sales are distributable to satisfy an financial obligations of the property, such as a mortgage or loan, and may also be used to cover costs associated with the property, including closing costs, late fees and legal fees, repairs, property insurance and taxes for one year, and the commission for a real estate agent or broker if they were involved in listing the property in the lottery system. The proceeds may further be used to provide at least a partial down payment to the displaced homeowner for use in a new home. A portion of the proceeds may also be distributed to the local municipality to offset debts. The invention also includes a method of conducting such a housing lottery.

For example, the tickets can be sold at least $1.00 per ticket for homes under $350,000.00 daily, like the “Fantasy 5” common in many communities, $2.00 to $20.00 for homes from $350,000 to $600,000.00, $3.00 to $20.00 for homes over $600,000.00 and $5.00 to $20.00 for homes over a $1,000,000.00. Each of these examples can use the instant ticket method which is drawn once a week. The actual value of the tickets will have to be customized for the best distribution to cover the administration of the lottery and allow for profits to sustain their Educational budgets and hopefully reduce taxes for all citizens.

Continuing this example, the tickets can be sold in several ways. They can be sold through the city, county, state, zip code or online universally across state lines with proceeds going to Educational funding for a particular city, state or zip code. A listing agent (a licensed real estate agent or mortgage broker) may earn a full or reduced commission for their participation in the real estate transaction. For each property sold through the lottery the listing agent, by listing the property to be sent to the lottery, might earn in the range of between 3% and 6% (determined by each municipality). The listing agent is responsible for the transaction being recorded through the title company for the winner of the property. The title company is responsible for making sure all fees are recorded correctly, all liens are paid-off, winning tax fees and closing cost are paid, similar to a traditional residential closing and the profits are given to the correct municipality for Educational funding, all within 1 to 3 months.

Accordingly, the housing lottery of the present invention will stabilize and eventually increase property values, since the outstanding liens, such as mortgages, on the foreclosed property will be paid using lottery ticket sales. Some of the lottery ticket sales may also be used to fund any repairs needed to the property. As a consequence, the invention will also stabilize the real estate market in general, as the values of surrounding properties will certainly increase once the property is repaired and sold through the lottery and debts are paid off.

Some of the proceeds of the lottery ticket sales may also go to the displaced homeowner for a down payment on a new home, therefore further spurring the real estate market. The present lottery system will also lead to a decrease in the number of abandoned properties in neighborhoods, since there will be fewer abandoned foreclosures. More people will also have homes as a result of the instant invention.

In addition to satisfying outstanding debts on foreclosed properties, proceeds from the lottery ticket sales may also be applied to the local government or municipality, such as to offset previous foreclosure debts, increase the tax base, and restore local coffers without extra taxes to the citizenry. All these aspects result in spurring the local economy. As the local economies rebound, there will be more money available to fund other desperately needed projects, and more importantly, jobs. In sum, the present invention provides a way of stabilizing the real estate market, assisting economic recovery and jobs creation at the local level where it is needed most.

These and other objects, features and advantages of the present invention will become clearer when the drawings as well as the detailed description are taken into consideration.

### IV. BRIEF DESCRIPTION OF THE DRAWINGS

For a fuller understanding of the nature of the present invention, reference should be had to the following detailed description taken in connection with the accompanying drawings in which:

FIG. 1 is a schematic representation of the system for a housing lottery of the present invention.

FIG. 2 is a schematic representation of additional aspects of the system of FIG. 1.

FIG. 3 is a schematic diagram of the method of the present invention. Like reference numerals refer to like parts throughout the several views of the drawings.

### V. DETAILED DESCRIPTION OF THE PREFERRED EMBODIMENT

The present invention is directed to a system and method for a housing lottery in which properties, such as foreclosures, may be “won” and the proceeds of lottery ticket sales are used to satisfy financial obligations associated with the property. More specifically, the system of the present invention includes at least one property for which at least one participant pays for one or more lottery tickets, and a lottery management authority that manages the sale of lottery tickets, conducts drawings for each property, and distributes the proceeds of the lottery ticket sales to satisfy outstanding debts, liens, and fees associated with the property sold via the lottery. The invention also includes a method of conducting a housing lottery as described.

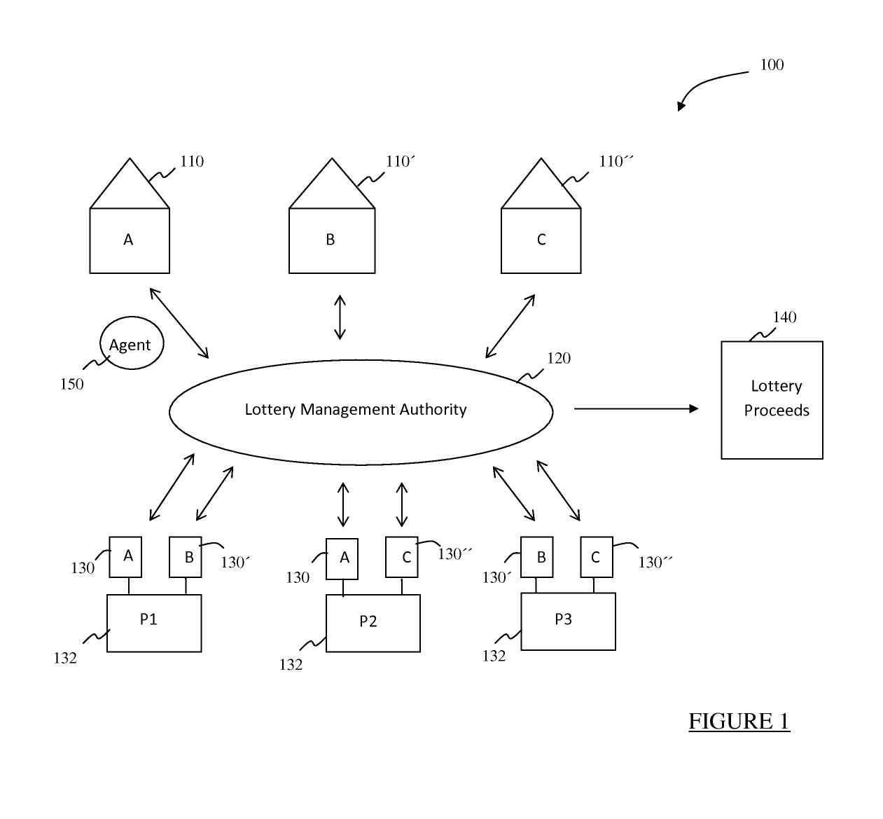

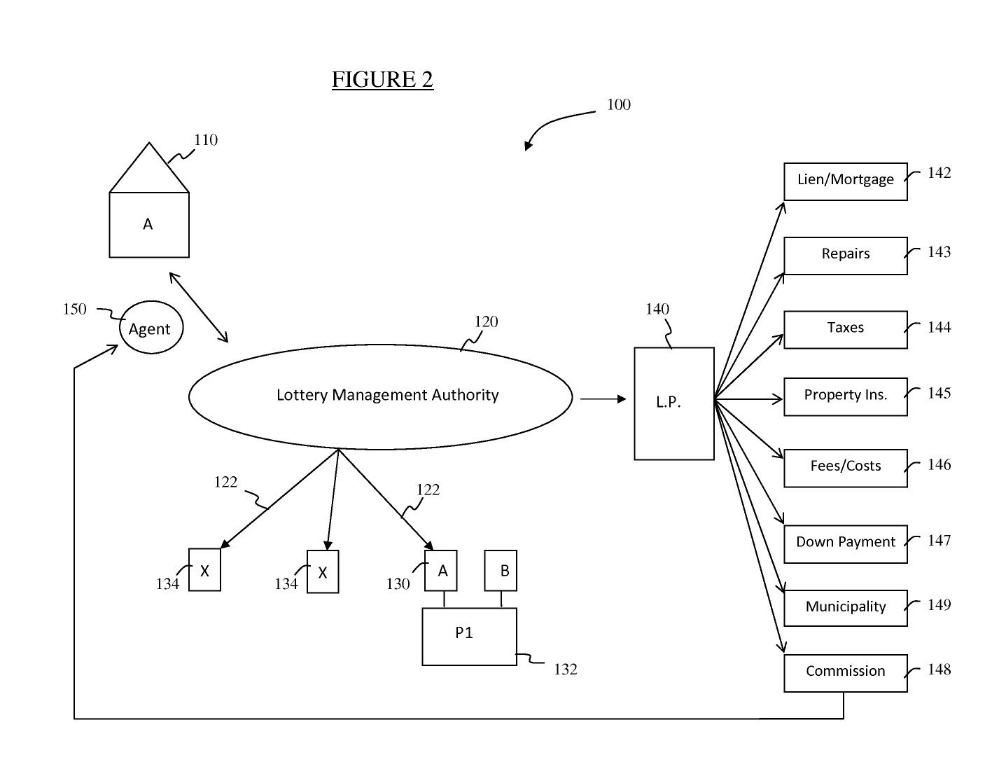

As depicted schematically through FIGS. 1 and 2, the housing lottery system 100 includes at least one property 110 identified to be sold through the lottery. Such property 110 may be any real estate property which the owner desires to have sold through the instant housing lottery system 100. In at least one embodiment, the property 110 may already be in foreclosure, or may be suitable for foreclosure or nearing foreclosure status.

In other embodiments, the property 110 need not be in foreclosure, but may nevertheless be subject to dire financial straits that make simply selling the property infeasible. For instance, the property 110 may have significant debts outstanding against it, which in some cases may exceed the value of the property. The property 110 may be encumbered by a “toxic loan” or an adjustable-rate mortgage, or “ARM” in which the interest rate has increased beyond what the homeowner can afford. It should be understood that the above are merely examples, and are not indicative of all possible financial hardships that could qualify a property 110 for listing with the housing lottery system 100.

The property 110 may be any real estate property. In some embodiments, the property 110 is residential in nature, such as a house, townhome, condominium, or mobile home. The property 110 may even include an entire building or complex of buildings containing multiple residential units, such as apartments or condominiums. In other embodiments, the property 110 is commercial in nature, such as a unit in a building or strip mall, warehouse, restaurant, office, retail space, etc. It may include just one unit or building, or may be the entire building containing multiple units or a complex of buildings.

Further, the property 110 may be located in any geographical area. For instance, it may be located in any state of the United States, in any county, and may be within city limits or lie outside city limits in unincorporated territory.

In at least one embodiment, the system 100 includes a plurality of properties 110, 110′, 110″ that may be sold through the lottery. These properties 110, 110′, 110″ need not be the same type of property, and or located in the same geographical area. In fact, they may have different values and/or different amounts of outstanding debts. For example, and by way of example only, one property 110 may be valued at around $100,000 while another property 110′ is valued at $300,000 and still another property 110″ is valued at $600,000. Moreover, any portion of a mortgage, loan, or other lien may be pending on the particular property 110, 110′, 110″, with various interest rates or repayment requirements for each.

The housing lottery system 100 also includes a lottery management authority 120 with which each property 110 are listed for inclusion in the lottery. The lottery management authority 120 may be any organization capable of facilitating the housing lottery described herein. For instance, in at least one embodiment the lottery management authority 120 is a municipality, such as a city, state, county, or other local government. It may be that the lottery management authority 120 is a branch, office, or division of a municipality, or may be a separate group or organization overseen by a local municipality.

In another embodiment, the lottery management authority 120 is a separate organization which works in conjunction with local municipalities, lenders, investors, realtors, brokers, and title companies to facilitate the housing lottery system 100. The lottery management authority 120 may be a private or public organization, or at least partially governmental in nature. It may be non-profit or for profit.

In another version the lottery management authority may be a banking institution, mortgage lender, mortgage servicer or other entity likely to have a real estate owned (REO) inventory. Similarly, a municipal taxing authority may have tax foreclosed properties and may act as, or with, a lottery management authority.

In at least one embodiment the lottery management authority 120 is located locally to the properties 110 being sold through the lottery, such as in the case where the lottery management authority 120 is a local municipality, such as a city or state government, or branch, division or office thereof, or a locally maintained company or organization. In other embodiments, the lottery management authority 120 may be centralized, such as to a particular region, or may be nationwide.

For example, the lottery management authority 120 may be a non-profit organization that coordinates lotteries of properties throughout a geographic region, such as the southeast United States or South Florida. In some cases the lottery management authority 120 may coordinate lotteries across the country, and may therefore have an online presence to facilitate such various lotteries in different areas. However, as will be described in greater detail hereinafter, the proceeds from the sale of tickets for that particular property 110 goes to help the economy and/or municipality local to that property 110. Also, it should be evident, that online or Internet presence is not limited to distant lottery management authorities 120. Even locally located and maintained lottery management authorities 120 may operate a website online for ease of use, access to greater numbers of potential participants, and easier distribution of information.

Properties 110 can be listed with the lottery management authority 120 in a number of ways. For instance, the owner of the particular property 110 may enroll it himself or herself directly. The lottery management authority 120 may also solicit and facilitate the listing of certain properties 110 therein, such as from banks and lenders. In addition, a listing agent 150 such as a realtor, real estate agent or mortgage broker may be used to enlist a particular property 110 with the lottery management authority 120.

The housing lottery system 100 also includes at least one lottery ticket 130 purchased by at least one participant 132 desirous of acquiring a particular property 110 that has been listed in the housing lottery. In at least one embodiment, the value of a particular lottery ticket 130 is based on the property value assessed for the corresponding property 110, according to value estimates determined at or near the time of listing the property 110 with the lottery management authority 120. In other embodiments, the value of a particular lottery ticket 130 is based on the amount of outstanding financial obligations for that property, such as a mortgage or loan.

The sale price of each lottery ticket 130 may further depend on a quantity of tickets 130 determined which must be sold to satisfy such financial obligations. Accordingly, the price of lottery tickets 130 may vary depending on the property 110 to which they correspond. However, the lottery ticket price is nominal in comparison to the value of the property 110. Moreover, there may be a tiered pricing scheme, so that the price for the lottery ticket 130 is at least somewhat proportional to the value of the corresponding property 110 or the financial obligation encumbering it.

For instance, as the value of a property 110 or its financial obligations increase, so too does the price of a corresponding lottery ticket 130. Generally and with reference to FIG. 1, one property 110 may have a certain value or amount of financial obligation, which would correspond to a particular price for a lottery ticket 130 for that property. A different property 110′ may have a different value or financial obligation, higher or lower, so the price of the lottery tickets 130′ correspond specifically to this property. Similarly, a third property 110″ having still a different value or financial obligation would have corresponding lottery tickets 130″ of a still different price.

More specifically, in one example lottery tickets 130 may be purchased for $1 each for properties 110 that are valued at $350,000 or less; $2 each for properties valued from $350,000 to $600,000; $3 each for properties valued at $600,000 to $1,000,000; and $5 each for properties valued at over $1,000,000. In another example, a lottery ticket 130 can be purchased for Si for a property valued at less than $300,000; for a property valued between $300,000 and $700,000; and 20 for a property valued at over $700,000. In a third example, lottery tickets may be purchased for $1 each for properties 110 owing less than $100,000 of outstanding financial obligation; $2 for properties having between $100,000 and $300,000 of outstanding financial obligation; and $5 for properties encumbered with over $300,000 of outstanding financial obligation. These are just a few exemplary illustrations, and are not intended to be limiting.

The actual prices of the various lottery tickets 130, 130′, 130″ may depend on a variety of factors, including but not limited to the local real estate market at the time of the housing lottery, the value of a particular property 110, 110′, 110″ fisted in the lottery, average amount of outstanding liens or other financial obligations on listed properties 110, 110′, 110″, an amount of tickets that would need to be sold to raise the money necessary to fully satisfy all financial obligations, local municipal financial considerations such as budgets and taxes, possible costs associated with conducting the housing lottery, and others.

The lottery tickets 130 may be sold and/or issued through the lottery management authority 120, or through a third party that contracts with the lottery management authority 120, such as convenience stores, gas stations, and other point-of-sale merchants. Moreover, in at least one embodiment the lottery tickets 130 are sold and purchased locally, such as in the same city, town, state, county, or zip code in which the desired listed property 110 is located, such as at point-of-sale locations. In another embodiment, lottery tickets 130 may be purchased online for properties 110 in a particular location.

To facilitate the sale of lottery tickets 130, the lottery management authority 120 may present information on each property 110 in the housing lottery to prospective participants 132 which can be used in making a determination for which properties 110 to purchase tickets 130.

For example, the lottery management authority 120 may establish and operate a website in which each property 110 listed in the housing lottery has its own webpage, containing relevant information about that property 110, such as but not limited to location (i.e. address), property value, number of rooms, amenities, neighborhood, school district, etc., as well as the lottery ticket value for that property and when the drawing for that property will be performed. Moreover, each webpage may have an option, such as a button or link to click, whereby a lottery ticket 130 for the property 110 shown on that webpage may be purchased online. Further, the website may be designed such that the various properties 110, 110′, 110″ listed in the housing lottery may be viewable and/or searchable by area, such as city, state, county, or zip code. In fact, different parts of the website may be devoted to different geographic areas in which properties are located. Still another part of the website may provide information on lottery drawings, including past winners and scheduled future drawings.

As seen in FIG. 1, there may be multiple participants 132, designated schematically as P1, P2, and P3. Each participant 132 may purchase more than one lottery ticket 130, 130′, 130″ if they wish, corresponding to whichever property 110, 110′, 110″ they desire to acquire, respectively. These lottery tickets 130, 130′, 130″ may have different price values, depending on the property value of the property 110, 110′, 110″ to which they correspond. As noted before, the participants 132 can view information on each property 110, 110′, 110″ listed in the housing lottery, such as online, at a kiosk or other point-of-sale location, etc., and may further purchase any number of desired lottery tickets 130, 130′, 130″ accordingly.

The lottery management authority 120 is responsible for conducting at least one drawing 122 for each property 110, as depicted in FIG. 2. For instance, the lottery management authority 120 may conduct a drawing(s) 122 for a property 110 that result in drawn tickets 134 which do not match any ticket sold, designated “X” in FIG. 2. However, the lottery management authority 120 may continue to conduct drawings 122 until a matching, or “winning” lottery ticket 130, designated “A” in FIG. 2, is identified. Such a winning ticket 130 will have previously been sold to a participant 132, who can then be notified and/or claim the corresponding property 110.

Each drawing 122 is particular to a specific property 110, such that only one property 110 may be sold in a single drawing 122. However, and as evidenced above, multiple drawings 122 may be conducted in order to identify a winning or matching ticket 130 for a given property 110. In at least one embodiment, drawings 122 for a particular property 110 are conducted at the same time, sequentially until a winning ticket is identified. In other embodiments, drawings 122 for the same property 110 may be spaced apart by an appropriate amount of time, such as hours, days, or weeks, to provide time in which a winning participant 132 may claim the property 110. If no participant 132 claims the property 110 within that set amount of time, another drawing(s) 122 may be conducted for that particular property 110. Additionally, there may be an interval of predetermined time between drawings 122 for different properties 110, 110′, 110″. Such time between drawings 122 is established by the lottery management authority 120 who conducts the drawings. In one embodiment, drawings 122 may be set to occur once per week. In another embodiment, drawings 122 occur twice per week. These are illustrative examples only, and are not meant to be limiting in any sense. Moreover, each area or locality may have its own drawings 122 at certain intervals, and the intervals for drawings 122 in one location may be different than that of another location. For instance, locations may be defined by the lottery management authority 120 by zip code, city, county, state, or other municipality.

Importantly, the drawings 122 are conducted by the lottery management authority 120 in accordance with all rules and regulations that may pertain to the geographic area in which the property 110 is located. Different areas may have different rules for conducting and managing lotteries and property conveyance. Accordingly, before a property 110 may be listed in the housing lottery system 100, the lottery management authority 120 must agree to comply with all local rules and regulations as may be established by the city, state, or county for the same.

The system 100 further includes lottery proceeds 140 resulting from the sale of lottery tickets 130, 130, and 130″. These lottery proceeds 140 are locally identified and/or maintained, such that lottery proceeds 140 from ticket sales for a particular property 110 are applied to the local municipality (e.g. city, county, state, etc.) where that property 110 is located. In this manner, the lottery proceeds 140 are used to benefit the local economy and real estate market.

As shown in FIG. 2, at least a portion of the lottery proceeds 140 are distributable to satisfy outstanding liens on the property 110 sold through the housing lottery system 100. For instance, in at least one embodiment, the lottery proceeds 140 are distributable to pay off any remaining mortgage 142 or other loan on the property 110. In such case, the lottery management authority 120 facilitates the remittance of mortgage or loan funds to the appropriate lending bank(s) or financial institution(s) to satisfy the outstanding debts. In this manner, the debts of the property 110 are paid off through the present housing lottery system 100.

In at least one embodiment, a portion of the lottery proceeds 140 are also distributable to cover the costs of any re airs 143 that are needed to be performed in the property 110 to place it in good condition for the next owner. Such repairs may be detailed and performed in accordance with regulatory protocol, such as a 203k loan or renovation format, so that the repaired property will be able to obtain a Certificate of Use. This also helps boost the future value of the property 110 and increase the neighborhood value as well.

A portion of the lottery proceeds 140 may also be distributable to cover the costs of future property taxes 144 and insurance 145 for the property for one year or more following the lottery drawing for this property 110. In this way the taxes and insurance may be “prepaid” for a predetermined amount of time through the lottery system 100 to protect against default. In some cases this may be more than a year or may be shorter.

Lottery proceeds 140 can be distributable to cover the fees and costs 146 associated with transferring the property 110 to the new owner, including but not limited to closing costs, late fees, and legal fees. This may also include any fees necessary to record the new ownership and title with the appropriate local agencies.

At least some of the lottery proceeds 140 are also distributable to cover at least a portion of a down payment 147 on a new home for the displaced, former homeowner. Such down payment 147 or deposit may be up to $20,000 in some embodiments to help provide a homeowner losing a property 110 through the housing lottery with a chance at a fresh start in a new home.

In certain embodiments, a listing agent 150 facilitates the listing of a particular property 110 in the housing lottery. Accordingly, a portion of the lottery proceeds 140 may also be used to pay the listing agent 150 a commission 148. The precise amount of commission 148 paid to a listing agent 150 will depend on the terms established by the lottery management authority 120 and agreed to the agent 150, as are appropriate for the local real estate market. By way of example, the commission 148 may be 1-3% or 3-6% of the property value or of the total lottery proceeds 140 generated for that particular property 110.

Moreover, the lottery proceeds 140 are further distributable to the local municipality as profits which may be used to offset debts 149 incurred by the municipality. These debts may be related to or the result of previous foreclosures, to increase the municipality's tax base, to offset previously low taxes, to restore funds to public projects, and other purposes as the municipality sees fit, in this manner, the present system. 100 not only restores stability to the local real estate market, but also replenishes revenues and restores a measure of financial security to the local municipality.

In conjunction with distributing the lottery proceeds 140, the title of the property 110 may also be transferred to the new owner. Satisfaction of liens and mortgages, as well as title transfer, may need to be recorded with the relevant state authority to abide by state and/or local rules, provide notice to bona fide purchasers, and perfect securities interests, etc. A listing agent 150, if responsible for listing the particular property 110 with the lottery management authority 120, may be responsible for facilitating and finalizing the transfer of title and recordation of notices with relevant state or local authorities. In the absence of a listing agent 150, the lottery management authority 120 is responsible for finalizing transfers and recording notices of the same. These finalizing steps, including the disbursement of lottery proceeds 140 as described above, may be performed within a certain predetermined amount of time, such as within 30 days of the lottery drawing 122.

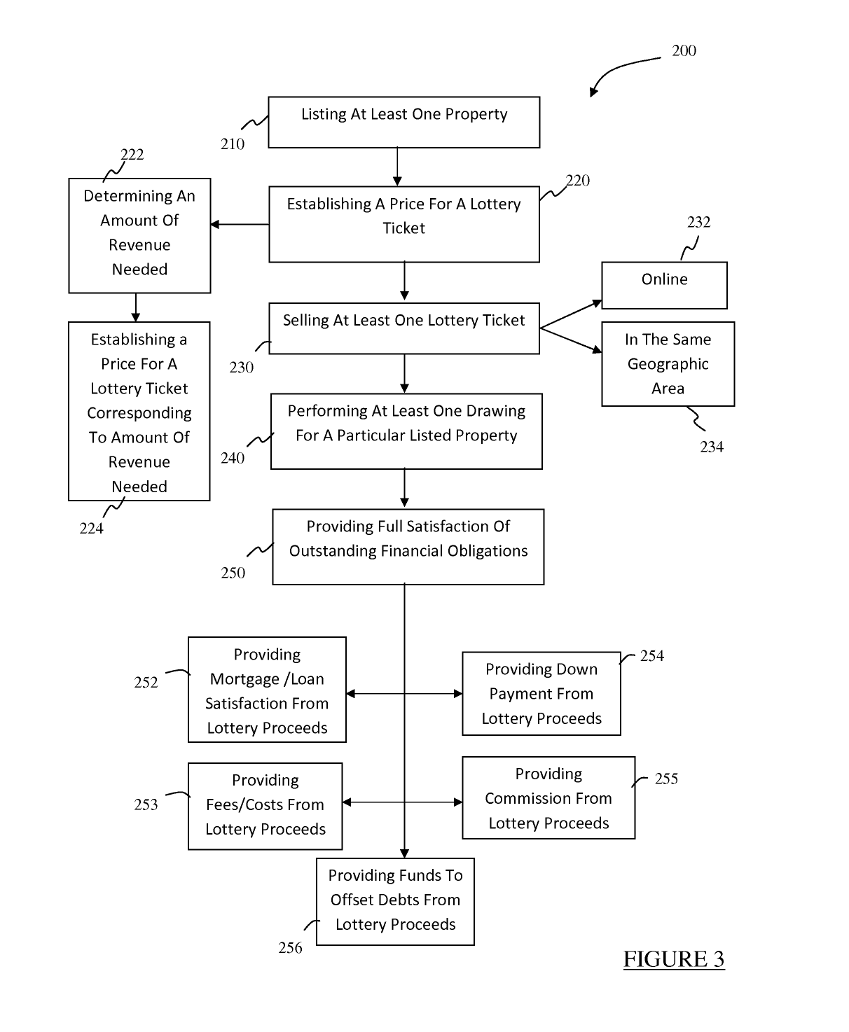

The present invention is also directed to a method of conducting a housing lottery, referred to generally as 200 and shown schematically in FIG. 3. This method. 200 applies to the system 100 described previously. Specifically, the method 200 includes listing at least one property for inclusion in the housing lottery, as at 210. Such listing 210 may be accomplished by a listing agent, an owner of a property, the lottery management authority, or any combination thereof. Moreover, the property or properties may be in a state of foreclosure or ripe for foreclosure, though it is certainly not necessary in all embodiments.

The method 200 further includes establishing a price for a lottery ticket for the listed property, as at 220. The price of the lottery ticket for a given property is established relative to the financial aspects of the property at the time of listing the property with the lottery system. For instance, as described previously, the price of each lottery ticket may be established based on a current value of the property relative to the local real estate market, or may be based on the amount of outstanding financial obligations encumbering the property at the time of listing, such as any remaining mortgage or loan amounts. Accordingly, establishing the price 220 may further include increasing the price of lottery tickets for higher valued properties or for properties with greater financial obligations. In any event, the ticket price for the lottery ticket is preferably nominal compared to the value of the property or amounts of outstanding financial obligations. For example, the price for a lottery ticket may be established as at least $1, and may be up to $20 or any denomination in whole or in part therebetween. In other instances, the lottery ticket price may be established at some amount exceeding $20.

Moreover, in at least some embodiments the method 200 includes determining an amount of revenue needed 224 to be generated from a sale of lottery tickets, as at 222. Such revenue should be at least sufficient to fully satisfy certain predetermined outstanding financial obligations of the property at the time of listing. For instance, such required revenue may be at least equal to the amount of a mortgage or loan granted for the property. It should be understood that the required revenue amount discussed herein is a threshold amount, and revenue in excess of this amount is contemplated and encouraged whenever possible.

Establishing a ticket price 220 may therefore further entail establishing a price of lottery tickets for sale corresponding to the amount of revenue needed to satisfy the outstanding financial obligations, as at 224. In further embodiments, a predetermined quantity of lottery tickets may be needed to be sold before a lottery drawing on that particular property is performed. This may also be considered a threshold number of tickets required for a drawing, and more would certainly be welcome. Accordingly, establishing a ticket price based on an amount of revenue needed 224 may be based, at least in part, on the predetermined quantity of tickets for a listed property that should be sold in order to reach the required revenue to meet the financial obligations of the property.

The method 200 further includes selling at least one lottery ticket for the identified and listed property, as at 230. As before, selling 230 may occur online 232 or at a point-of-sale located within the same geographical area 234 as the corresponding property. A website or other material may be used to present information on the property so that it is viewable, available, or otherwise accessible to a potential lottery participant, so that they may determine whether or not to purchase a lottery ticket for the property. Moreover, selling 230 may include selling at least a predetermined quantity of lottery tickets for the listed property, such as would be necessary to reach a required revenue to satisfy at least predetermined financial obligations on the property.

The method 200 includes performing at least one drawing for a particular property, as at 240. This may occur one time or multiple times as may be necessary to identify a winning lottery ticket for the particular property. Drawings may be performed at predetermined time intervals, which may be weekly such as once or twice a week, for example. Moreover, performing drawing(s) 240 is accomplished in accordance with the rules and procedures of the local municipality in which the property is located. It may therefore be understood that, since properties may be located in many different geographic areas and therefore subject to differing laws relating to lotteries, that performing drawings 240 will comply with whatever the local laws may be for that particular geographic area, and may therefore be as diverse as the various laws and regulations require.

The method 200 also includes providing full satisfaction of outstanding financial obligations on the property sold through the lottery, as at 250. For instance, this may include providing payment of the remaining outstanding mortgage or loan to the mortgage holder or lender, or municipal taxing authority, as at 252, from the proceeds of the lottery ticket sales.

In some embodiments, the method 200 also includes providing fees associated with the listed property, as at 253. These fees are provided from the lottery ticket sales, and may include taxes owed for the listed property (such as property taxes), property taxes to be incurred in a subsequent time period such as one year, property insurance owed and owing up to a predetermined time such as one year, closing costs, late fees, legal fees, and other relevant costs or fees.

The method 200 may also include providing funds to a displaced homeowner of a listed property for use in a down payment on another property, as at 254. Such down payment funds are provided from the proceeds of lottery ticket sales for the property of the previous, displaced homeowner.

When the services of a listing agent are used, the method 200 further includes providing a commission to the listing agent, as at 255. Such commission is particular to a property that agent lists with the lottery management authority. As explained before, the amount of commission is set by the lottery management authority and may represent a percentage of total proceeds from lottery ticket sales for a particular property that agent listed.

In at least one embodiment, the method 200 includes providing funds to a local municipality to offset debts, as at 256. Such debts may be the result of previous foreclosures, low taxation, budget cuts, and other financial concerns of the municipality. Funds provided to offset debts 256 are taken from the proceeds of lottery ticket sales for properties in that particular municipality or area. These funds may also represent any profits obtained from the sale of lottery tickets for a given property once funds for other purposes are removed.

In another variety of the invention scratch-off tickets are used. Similar to many other lottery tickets an opaque film is designed to be removed by the end user by lightly scratching the film with, for example, a coin or fingernail, to remove the opaque film revealing the writing below. In but one possibility within the scope of the balance of this invention an address or other identifying codes are hidden and then revealable under the opaque film. In this sense the actual prize (e.g. the property subject of the lottery) is instantly revealed to the winner.

In another preferred version the lottery is administered by and or is designed to provide a financial benefit to a Department of Education. Department of Education is intended to include a governmental or quasi-governmental agency of the local, state or federal government. It should be appreciated that some jurisdictions have alternative names for a body governing, regulating, administering or otherwise related to an educational system or institution.

A preferred version of the invention can be fairly described as a system for a housing lottery, comprising at least one property identified to be sold through the lottery. The system has a lottery management authority with which said at least one property is listed for inclusion in the lottery. At least one lottery ticket purchased by at least one participant desirous of acquiring said at least one property, typically a member of the public. The lottery proceeds resulting from the sale of said at least one lottery ticket to said at least one participant and in some cases others. The lottery management authority is responsible for conducting at least one lottery drawing per said at least one property and distributing said lottery proceeds, possibly daily weekly or monthly. At the conclusion of the lottery at least a portion of said lottery proceeds distributable to satisfy at least outstanding liens on said at least one property.

This example can further include that at least one property is suitable for foreclosure, is in foreclosure or has been foreclosed. The lottery management authority may be a municipality that is local to said at least one property or could be remotely administered. Alternatively, the lottery management authority comprises at least one of city, state, county, and local government. In another variation, at least a portion of said lottery proceeds are distributable to satisfy an outstanding mortgage or tax debt on the property subject of the lottery. A portion of the proceeds of the lottery may also be distributable to cover costs of repairs to said at least one property, to cover taxes and property insurance of the subject property for at least one year following the corresponding lottery drawing for said at least one property to benefit the lottery winner, may cover fees associated with the transfer of that property. In another version, part of the proceeds are distributable to cover at least a part of a down payment for a new home for a displaced owner (i.e. the person whose home has been lost and is a subject of the lottery). Some of the costs could also be distributable to a municipality where the subject property is located to offset other debts of the municipality related to the transaction and history of the property. Further, the listing agent responsible for listing the property with said lottery management authority or the broker or mortgage broker or bank may share in the proceeds as payment, repayment, commission or otherwise.

The invention also includes a method of conducting a housing lottery comprising listing at least one property for inclusion in the housing lottery and establishing a price for a lottery ticket for the listed property relative to at least the current value of the property at the time of listing. Then, selling at least one lottery ticket, but likely thousands, for the identified and listed property is completed in a lottery style. At least one drawing for a particular listed property is held, and possibly multiple drawings, until a winning lottery ticket for the particular listed property is identified. The method then includes providing full satisfaction of at least predetermined outstanding financial Obligations on the property sold through the lottery from the proceeds of lottery ticket sales.

This example can further be characterized in that the listed property is suitable for foreclosure by a lender or taxing authority. In another variation, the listing of the subject property includes providing information specific to that property in a manner that is accessible to potential lottery participants. Generally, establishing a price for a lottery ticket relative to an amount of predetermined outstanding financial obligation for the property is done prior to the sales of lottery tickets. In an important version the sales of the lottery tickets occurs in the same geographic area where the listed property is located, but this is not required in the case where the internet is used or where tickets may be attractive to those outside of the area where the properties are located. The drawings for different listed properties at predetermined time intervals or may happen simultaneously. The method may also include providing a commission to a listing agent or other involved party such as mortgage broker who lists a property with the lottery management authority from the proceeds of lottery ticket sales. Further, payments from the lottery proceeds may include providing full satisfaction of outstanding liens on the listed property as well as optionally providing payment of the remaining outstanding mortgage to the mortgage holder from the proceeds of lottery ticket sales and fees for other financial obligations related to the property such as repairs, taxes owed for the listed property, property insurance owed for the listed property, closing costs, legal fees, late fees and funds to the local municipality to offset debts from the proceeds of lottery ticket sales. The method may also include providing funds to a displaced homeowner of the listed property for a down payment on another property from the proceeds of lottery ticket sales, in effect resulting in two winners: the lottery winner and the former owner of the property.

Another version of the claimed method of conducting a housing lottery comprises listing at least one property for inclusion in the housing lottery and determining an amount of revenue needed to be generated from a sale of a predetermined quantity of lottery tickets for the listed property to satisfy at least predetermined outstanding financial obligations of the property as of the time of listing. Thus is established a price and quantity of lottery tickets for sale corresponding to the amount of revenue needed to satisfy the predetermined outstanding financial obligations. In a lottery selling at least the predetermined quantity of lottery tickets for the identified and listed property is preferred in conducting at least one drawing for a particular listed property until a winning lottery ticket for the particular listed property is identified. Then the lottery administering body provides full satisfaction of the predetermined outstanding financial obligations to creditors, lenders and others, as described above, from the proceeds of lottery ticket sales.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for a housing lottery, comprising:
at least one property identified to be sold through the lottery;
a lottery management authority with which said at least one property is listed for inclusion in the lottery;
at least one lottery ticket purchased by at least one participant desirous of acquiring said at least one property;
lottery proceeds resulting from the sale of said at least one lottery ticket to said at least one participant;
said lottery management authority responsible for conducting at least one lottery drawing per said at least one property and distributing said lottery proceeds; and
at least a portion of said lottery proceeds distributable to satisfy at least outstanding liens on said at least one property.

2. The system as recited in claim 1 wherein said at least one property is suitable for foreclosure.

3. The system as recited in claim 1 wherein lottery management authority comprises a municipality that is local to said at least one property.

4. The system as recited in claim 3 wherein said lottery management authority comprises at least one of city, state, county, and local government.

5. The system as recited in claim 1 wherein at least a portion of said lottery proceeds are distributable to satisfy an outstanding mortgage on said at least one property.

6. The system as recited in claim 1 wherein at least a portion of said lottery proceeds are distributable to cover costs of repairs to said at least one property.

7. The system as recited in claim 1 wherein at least a portion of said lottery proceeds are distributable to cover taxes and property insurance for said at least one property for at least one year following the corresponding lottery drawing for said at least one property.

8. The system as recited in claim 1 wherein at least a portion of said lottery proceeds are distributable to cover fees associated with said at least one property.

9. The system as recited in clamp 1 wherein at least a portion of said lottery proceeds are distributable to cover at least a part of a down payment for a new home for a displaced owner of said at least one property sold through the lottery.

10. The system as recited in clamp 1 wherein at least a portion of said lottery proceeds are distributable to a municipality local to said at least one property to offset debts of the municipality.

11. The system as recited in claim 1 further comprising a listing agent responsible for listing a particular one of said at least one property with said lottery management authority.

12. The system as recited in claim 11 wherein at least a portion of said lottery proceeds are distributable to said listing agent as commission.

13. A method of conducting a housing lottery, comprising:
listing at least one property for inclusion in the housing lottery;
establishing a price for a lottery ticket for the listed property relative to at least the current value of the property at the time of listing;
selling at least one lottery ticket for the identified and listed property;
performing at least one drawing for a particular listed property until a winning lottery ticket for the particular listed property is identified; and
providing full satisfaction of at least predetermined outstanding financial obligations on the property sold through the lottery from the proceeds of lottery ticket sales.

14. The method as recited in claim wherein the listed property is suitable for foreclosure.

15. The method as recited in claim 13 wherein listing at least one property includes providing information specific to the listed property in a manner that is accessible to potential lottery participants.

16. The method as recited in claim 13 further comprising establishing a price for a lottery ticket relative to an amount of predetermined outstanding financial obligation for the property.

17. The method as recited in claim 13 wherein selling at least one lottery ticket occurs in the same geographic area where the listed property is located.

18. The method as recited in claim 13 wherein selling at least one lottery ticket occurs online.

19. The method as recited in claim 13 further comprising performing drawings for different listed properties at predetermined time intervals.

20. The method as recited in claim 19 wherein performing drawings occurs weekly.

21. The method as recited in claim 13 further comprising providing a commission to a listing agent who lists a property with the lottery management authority from the proceeds of lottery ticket sales.

22. The method as recited in claim 13 wherein providing full satisfaction of outstanding liens on the listed property includes providing payment of the remaining outstanding mortgage to the mortgage holder from the proceeds of lottery ticket sales.

23. The method as recited in claim 13 further comprising providing fees associated with the listed property from the proceeds of lottery ticket sales to satisfy other financial obligations.

24. The method as recited in claim 23 wherein the fees include at least one of taxes owed for the listed property, property insurance owed for the listed property, closing costs, legal fees, and late fees.

25. The method as recited in claim 13 further comprising providing funds to a displaced homeowner of the listed property for a down payment on another property from the proceeds of lottery ticket sales.

26. The method as recited in claim 13 further comprising providing funds to the local municipality to offset debts from the proceeds of lottery ticket sales.

27. A method of conducting a housing lottery, comprising:
listing at least one property for inclusion in the housing lottery;
determining an amount of revenue needed to be generated from a sale of a predetermined quantity of lottery tickets for the listed property to satisfy at least predetermined outstanding financial obligations of the property as of the time of listing;
establishing a price and quantity of lottery tickets for sale corresponding to the amount of revenue needed to satisfy the predetermined outstanding financial obligations;
selling at least the predetermined quantity of lottery tickets for the identified and listed property;
performing at least one drawing for a particular listed property until a winning lottery ticket for the particular listed property is identified; and
providing full satisfaction of the predetermined outstanding financial obligations from the proceeds of lottery ticket sales.
